(19) United States
(12) Patent Application Publication
(10) Pub. No.: US 2008/0104644 A1
(43) Pub. Date: May 1, 2008

(54) Video Transferring Apparatus and Method

(76) Inventors: Youhei SATO, Tokyo (JP); Kaoru Konishi, Kawasaki (JP); Akira Date, Kunitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/869,245

(22) Filed: Oct. 9, 2007

(30) Foreign Application Priority Data
Oct. 31, 2006 (JP) 2006-295467

(51) Int. Cl. H04N 7/173; H04N 5/95

(52) U.S. Cl. 725/90; 386/68

(57) ABSTRACT

The present invention relates to a technology for satisfactorily realizing trick play in a video-on-demand system that transmits video contents to video receivers. For example, even when the interval between key frames which is coded in intra-frame coding is unequal and the data size of a key frame is not uniform, trick play can be achieved using the key frames within a permissible transmission bit rate. Herein, the transmission start time instant and transmission completion time instant of each key frame that should be transmitted are calculated. If the transmission completion time instant of a preceding key frame and the transmission start time instant of a succeeding key frame are incompatible with each other, the transmission of the succeeding key frame is canceled. If the above time instants are compatible, the succeeding key frame is transmitted at the transmission start time instant.

### CLAIM OF PRIORITY

The present application claims priority from Japanese application JP-2006-295467 filed on Oct. 31, 2006, the content of which is hereby incorporated by reference into this application.

### BACKGROUND OF THE INVENTION

(1) Field of the Invention

Part of the present invention relates to a technology for satisfactorily realizing trick play such as fast-forward in a video-on-demand system that transmits video contents to video receivers over a network.

(2) Description of the Related Art

In recent years, various video-on-demand (VOD) services have debuted along with an impending demand for a video-on-demand system. In addition to a style in which a personal computer (PC) connected on the Internet is used to view a picture made available by the VOD system, a style in which a set-top box (STB) is connected to a television in order to receive the VOD services at home has emerged.

In such a VOD system, when video equipment (such as video home system (VHS), digital versatile disk (DVD) player, or a hard disk drive (HDD) recorder) is used to view a picture in trick play mode such as fast-forward mode or rewind mode instead of normal play (standard-speed play) mode, a video distribution apparatus produces a video stream for use in trick play in response to a viewer's request, and delivers the video stream.

According to a technology described in Japanese Patent Application Laid-Open Publication No. H10-32809, a video server includes a stream control means 101, which determines a key frame read interval and a key frame interval that satisfy a play speed designated by a terminal, for the purpose of providing a video-on-demand system that can realize fast-forward trick play to be performed accurately at an arbitrary speed that is multiple times higher than a normal speed. The determined key frame interval is transferred to the terminal. The video server reads a key frame from a bit stream 1a with the key frame read interval, which is determined by the stream control means, and transmits the read key frame to the terminal. The terminal plays the stream received from the video server with the key frame interval, which is transferred from the stream control means, between adjoining reproductions. Owing to this system, the terminal is described to be able to accurately realize trick play to be performed at an arbitrary speed that is multiple times higher than a normal speed and designated by the terminal.

### SUMMARY OF THE INVENTION

The technology described in Japanese Patent Application Laid-Open Publication No. H10-32809 calculates the key frame read (transmission) interval and key frame interval for the trick play to be performed at an arbitrary speed, which is multiple times higher than a normal speed, on the assumption that the time interval between key frames to be read from a video content (video stream) remains constant.

However, as far as a video content that is coded while being compressed is concerned, key frames may not appear at constant intervals. When such a content is delivered, if the technology described in Japanese Patent Application Laid-Open Publication No. H10-32809 is applied, a picture becomes hard to see due to a temporal variation. Incidentally, the key frame shall be one of frames constituting a picture that is coded while being compressed and shall be coded in intra-frame coding.

Moreover, when a minimum key frame interval is obtained, a mean value of data lengths or data sizes (numbers of bits) of all key frames included in a video stream is employed. However, the key frames have different data lengths. Consequently, even when a key frame internal is determined to be a value larger than the minimum key frame interval, a predetermined permissible transmission bit rate may be instantaneously exceeded. In this case, a buffer included in a terminal overflows with data, and a picture is discontinued or partly lost.

In contrast, a key frame may not be transmitted because a reproduction time interval is unequal, though the data length of the key frame is tolerated by a transmission bit rate. In this case, the number of key frames constituting a picture to be played decreases, and the picture cannot therefore be played with original picture quality. Moreover, according to the technology described in Japanese Patent Application Laid-Open Publication No. H10-32809, an algorithm to be employed differs between when trick play is performed at a speed that is an integral multiple of a normal speed and when trick play is performed at a speed that is a non-integral multiple of the normal speed. This makes processing complex.

Accordingly, there are provided a video transferring apparatus and method intended to perform trick play using key frames without exceeding a permissible transmission bit rate even when the interval between key frames is unequal and the data size of a key frame is not uniform.

Specifically, for example, a video transferring apparatus includes: a play control command reception unit that receives a request for trick play of a video content from a video receiver; a media accumulation unit in which video contents are accumulated; a key frame management table in which pieces of information on key frames that are used for trick play and are included in the video contents accumulated in the media accumulation unit are recorded; a stream transmission unit that reads a video content from the media accumulation unit and transmits the read video content to the video receiver; and a trick play control unit that successively selects key frames, which should be transmitted, by referencing the key frame management table in response to the trick play request received by the reproductive control command reception unit, and that allows the steam transmission unit to read and transmit the selected key frames. The trick play control unit calculates the transmission start time instant and transmission completion time instant of each of the key frames that should be transmitted, and decides whether the transmission completion time instant of a preceding key frame and the transmission start time instant of a succeeding key frame are incompatible with each other. If the transmission completion time instant and transmission start time instant are incompatible with each other, the transmission of the succeeding key frame is canceled. If the transmission completion time instant and transmission start time instant are compatible with each other, the succeeding key frame is transmitted at the transmission start time instant.

The key frame management table contains a leading packet number of each key frame, a trailing packet number thereof, and a time stamp thereof. The trick play control unit checks the leading packet number of each key frame for the transmission start time instant thereof, and determines the transmission start time instant by extending or shortening the interval between adjoining transmission start time instants according to a requested speed of trick play. For the transmission completion time instant of each key frame, the trick play control unit checks the leading packet number and trailing packet number of each key frame, and determines the transmission completion time instant by adding the time, which is required for transmitting each key frame at a predetermined bit rate, to the transmission start time instant.

For example, according to a video transferring method, when a request for trick play of a video content is received from a user, key frames to be used for trick play are successively retrieved from an accumulated video content. The transmission start time instant and transmission completion time instant of each of the key frames are calculated under the condition for the requested trick play. A decision is made on whether the transmission completion time instant of a preceding key frame and the transmission start time instant of a succeeding key frame are incompatible with each other. If the transmission completion time instant and transmission start time instant are incompatible with each other, the transmission of the succeeding key frame is canceled. If the transmission completion time instant and transmission start time instant are compatible with each other, the succeeding key frame is transmitted at the transmission start time instant.

According to the above concrete example, even when the interval between adjoining ones of key frames to be used for trick play is unequal and the data size of a key frame is not uniform, a user can view a picture of satisfactory quality in trick play mode.

### BRIEF DESCRIPTION OF THE DRAWINGS

These and other features, objects and advantages of the present invention will become more apparent from the following description when taken in conjunction with the accompanying drawings wherein:

FIG. 1 shows the configuration of an embodiment of a video distribution system including a video distribution apparatus;

FIG. 2 shows an example of the hardware configuration of the video distribution apparatus;

FIG. 3 shows an example of the hardware configuration of a video receiver;

FIG. 4 shows an example of the structure of a key frame management table held in the video distribution apparatus;

FIG. 5A, FIG. 5B, and FIG. 5C are explanatory diagrams showing an example of making a decision on whether a key frame can be transmitted;

FIG. 6 is a flowchart describing an example of a flow of distribution achieved in a first embodiment;

FIG. 7 shows an example of a temporal change in an occupancy of a buffer included in the video receiver; and

FIG. 8 is a flowchart describing an example of a flow of distribution achieved in a second embodiment.

### DESCRIPTION OF THE EMBODIMENTS

Referring to the drawings, embodiments of the present invention will be described below.

### First Embodiment

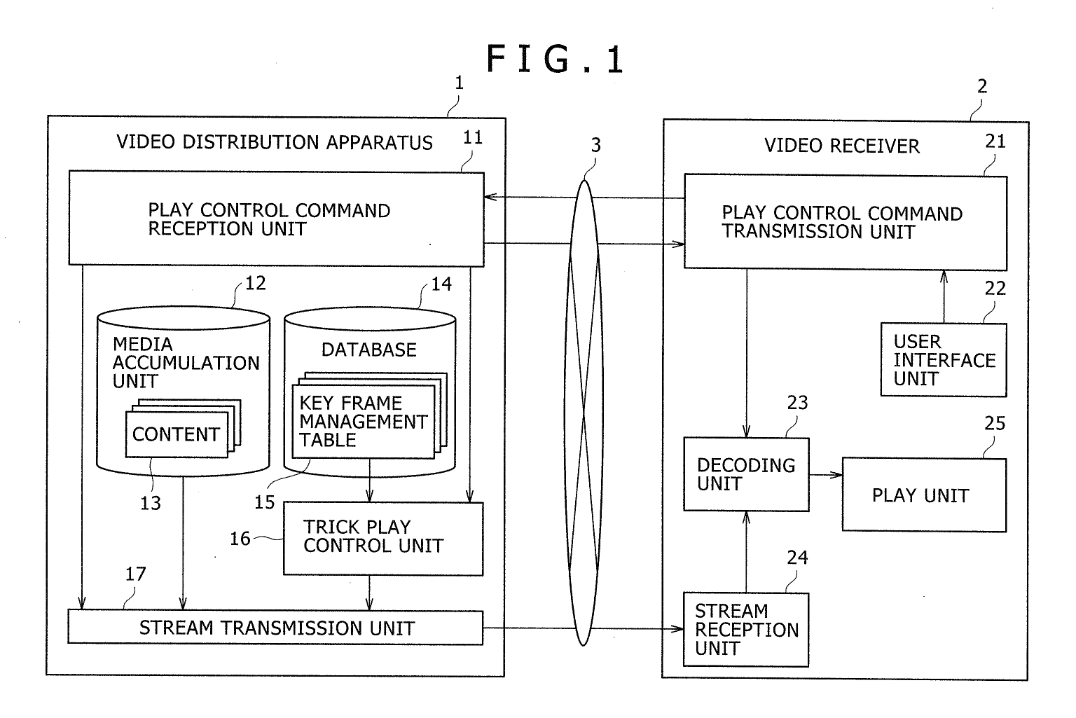

FIG. 1 shows the configuration of an embodiment of a video distribution system (VOD) system including a video distribution apparatus. In the present embodiment, the video distribution apparatus 1 distributes audiovisual (AV) contents over a communication medium 3. A user receives and views a content using a video receiver 2 (television, set-top box (STB), personal computer (PC), digital video recorder (DVR), etc.). When multiple video receivers 2 are connected, requested AV contents can be distributed to multiple users.

The video receiver 2 transmits an instruction concerning a video program (AV content), which a user wants to view, or a play control condition (normal play, fast-forward trick play, rewind trick play, pause, etc.) to the video distribution apparatus 1. The video distribution apparatus 1 receives the delivery instruction from the video receiver 2, and delivers data of the designated video program. When instructed to perform trick play (fast-forward or rewind), the video distribution apparatus 1 reconstructs the video program data according to the condition for trick play, and delivers the resultant data. When receiving an instruction of terminating play from the video receiver or completing delivery of predetermined data, the video distribution apparatus 1 terminates delivery of a video program. The communication medium 3 is a wired medium formed with an optical network, a CATV, or a telephone network, or a wireless medium, and refers to a public communication network or a leased communication network. Apparatuses interconnected over the communication medium 3 transmit or receive AV content data or a control command according to a predetermined communication protocol.

Next, the internal configurations of the video distribution apparatus 1 and video receiver 2 respectively will be described from the functional viewpoint.

The video distribution apparatus 1 includes a play control command reception unit 11, a media accumulation unit 12, a database 14, a trick play control unit 16, and a stream transmission unit 17.

The play control command reception unit 11 has the ability to communicate with the video receiver 2 connected on the communication medium 3, and receives a play control command sent from the video receiver 2. If the received play control command signifies normal play or pause, the play control command reception unit 11 transfers the command to the stream transmission unit 17. If the received play control command signifies trick play (fast-forward trick play or rewind trick play), the play control command reception unit 11 transfers the command to the trick play control unit 16. For communication of the reproductive control command, a convention of, for example, a real time streaming protocol is employed.

In the media accumulation unit 12, AV contents 13 to be delivered to the video receiver 2 are accumulated. The AV content 13 is, for example, a video program in which video data, audio data, data of caption, and data of a superimposed character string are multiplexed, encoded and compressed according to a predetermined format, and preserved in the form of a file. The content 13 has frames thereof, which are required for play, read by the stream transmission unit 17. The read frames are delivered as a stream to the video receiver 2. The database 14 holds a key frame management table 15 that is needed for trick play. In the key frame management table 15, pieces of information on key frames to be used for trick play are recorded in association with each of the contents 13 held in the media accumulation unit 12.

The trick play control unit 16 selects key frames, which are included in a video program to be delivered and should be transmitted, according to a trick play command transferred from the play control command reception unit 11, and calculates the transmission start time instants of the respective key frames. At this time, the trick play control unit 16 references the key frame management table 15 held in the database 14 so as to select frames to be transmitted and calculate the transmission start time instants of the respective frames. The stream transmission unit 17 reads data of a predetermined video program selected from the contents 13 according to reproductive control data transferred from the play control command reception unit 11 or trick play control unit 16, and delivers the read data in the form of a stream to the video receiver 2 over the communication medium 3.

The video receiver 2 includes a play control command transmission unit 21, a user interface unit 22, a decoding unit 23, a play unit 25, and a stream reception unit 24.

In response to an instruction concerning reproduction of a video program sent via the user interface unit 22, the play control command transmission unit 21 transmits a reproductive control command such as a reproduction start request to the video distribution apparatus 1. The user interface unit 22 provides a user with a selection screen image through which a program to be viewed is selected or a reproductive handling screen image through which a picture being viewed is handled. When the user selects a program or enters a reproductive handling instruction, the user interface unit 22 transfers the selected program or entered instruction as a reproductive instruction to the play control command transmission unit 21.

The stream reception unit 24 receives streams delivered from the video distribution apparatus 1 over the communication medium 3. At this time, the received streams are temporarily stored in a buffer memory. The stored streams are sequentially fetched by the decoding unit 23.

The decoding unit 23 decodes a received stream, transforms the resultant stream into video data and audio data, and transfers the video data and audio data to the play unit 25. At this time, the decoding unit 23 receives reproductive control data from the play control command transmission unit 21, and decides whether the stream should be decoded in normal play mode or trick play (fast-forward trick play or rewind trick play) mode. For normal play, while a time stamp contained in the stream is used to attain synchronism, decoding is performed. On the other hand, for trick play, the time stamp is ignored. Every time the stream reception unit 24 receives a stream, the decoding unit 23 decodes the stream. Moreover, for trick play, even when video data or audio data other than data of a key frame is contained, the data is not decoded but discarded. The play unit 25 displays or reproduces the video data or audio data, which is decoded by the decoding unit 23, using a monitor or a loudspeaker.

The capabilities of the video distribution apparatus 1 and video receiver 2 can be realized with the hardware configurations described below.

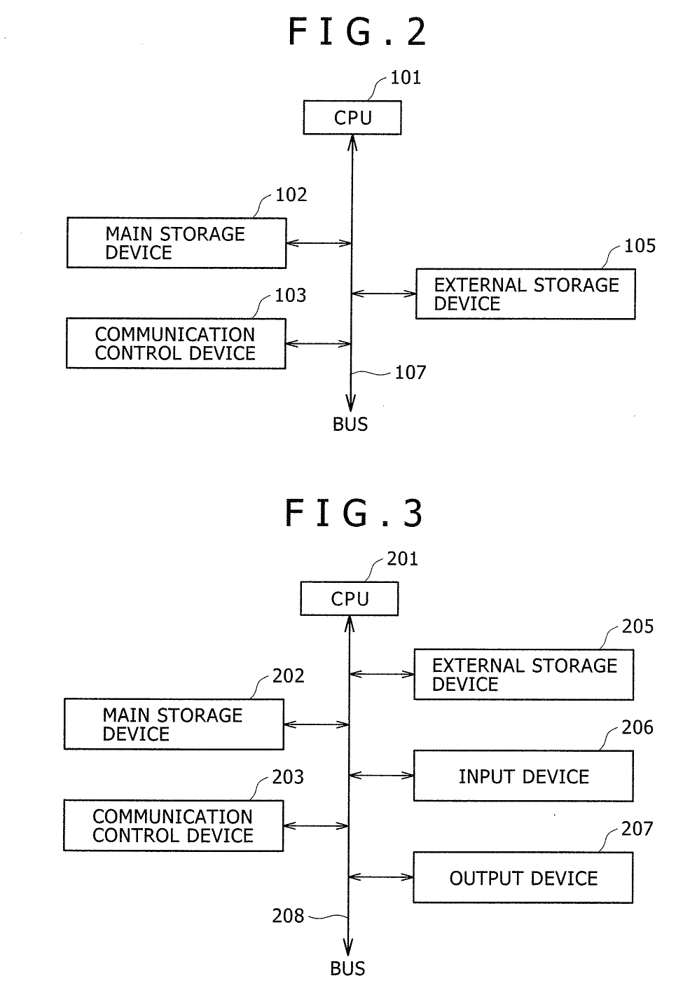

FIG. 2 shows an example of the hardware configuration of the video distribution apparatus 1 shown in FIG. 1. The video distribution apparatus 1 includes a central processing unit (CPU) 101, a main storage device 102, a communication control device 103, and an external storage device 105 which are interconnected over a bus 107.

The CPU 101 performs predetermined actions according to programs stored in advance in the main storage device 102 or external storage device 105. The main storage device 102 which is used as a work area and in which required programs are stored is realized with a RAM or a ROM. The communication control device 103 transmits or receives data to or from other apparatuses connected on the communication medium 3, and is realized with a modem, a network adaptor, or a radio transmission/reception device. The external storage device 105 in which control programs for the video distribution apparatus 1 and operational information are stored is realized with a semiconductor disk, a hard disk drive (HDD), or an optical disk.

The associations with functional blocks shown in FIG. 1 will be described below. Programs serving as the play control command reception unit 11, trick play control unit 16, and stream transmission unit 17 are stored in the main storage device 102 or external storage device 105, and executed by the CPU 101. Delivery of a stream to the video receiver 2 and transmission or reception of a command to or from the video receiver 2 are performed by the communication control device 103. The media accumulation unit 12 is realized with the external storage device 105, and the database 14 and key frame management table 15 are held in the external storage device 105.

FIG. 3 shows an example of the hardware configuration of the video receiver 2 shown in FIG. 1. The video receiver 2 includes a central processing unit (CPU) 201, a main storage device 202, a communication control unit 203, an external storage device 205, an input device 206, and an output device 207 which are interconnected over a bus 208.

The CPU 201 performs predetermined actions according to programs stored in advance in the main storage device 202 or external storage device 205. The main storage device 202 which is used as a work area and in which required programs are stored is realized with a RAM or a ROM. The communication control unit 203 that transmits or receives data to or from apparatuses connected on the communication medium 3 is realized with a modem, a network adaptor, or a radio transmission/reception device. The external storage device 205 in which control programs for the video receiver 2 and operational data therefor are stored is realized with a semiconductor disk, a hard disk drive (HDD), or an optical disk.

The input device 206 which a user uses to give an instruction to the video receiver 2 or to perform a manipulation on the video receiver 2 is realized with, for example, a remote controller employed in a television set or a keyboard and a mouse employed in a personal computer. The output device 207 on which information is displayed in order to respond to a user's manipulation is realized with any of various picture output devices (Braun tube, cathode-ray tube (CRT), liquid crystal display, plasma display panel (PDP), organic electroluminescent display, and projector) or an audio output device (loudspeaker or headphone).

The associations with functional blocks shown in FIG. 1 will be described below. Programs serving as the play control command transmission unit 21, user interface unit 22, decoding unit 23, and stream reception unit 24 are stored in the main storage device 202 or external storage device 205, and executed by the CPU 201. Transmission of a play control command to the video distribution apparatus 1 and reception of a steam delivered from the video distribution apparatus 1 are performed by the communication control device 203. A buffer memory in which a received stream is stored is included in the main storage device 202 or external storage device 205. The input device 206 receives a user's entry that selects a program or a play operation instruction given by a user. The output device 207 presents a video program selection screen image or a play operation screen image, through which a picture being viewed is handled, to a user. The play unit 25 to be used to view a delivered content is realized with the output device 207. Incidentally, the decoding unit 23 may be realized with dedicated hardware instead of software. In this case, decoding can be speeded up.

The hardware configurations shown in FIG. 2 and FIG. 3 are mere examples. The present invention is not limited to the hardware configurations. For example, the output device 207 may be realized with an external device such as a television. In this case, the body of the video receiver 2 includes a television signal production device such as a digital-to-analog converter, and the external device is connected to the video receiver over an audiovisual (AV) cable or a coaxial cable.

Next, a description will be made of how the video distribution apparatus 1 included in the video distribution system in accordance with the present embodiment produces and delivers a content to be subjected to trick play. For trick play, among frames constituting a content, key frames coded in intra-frame coding are employed.

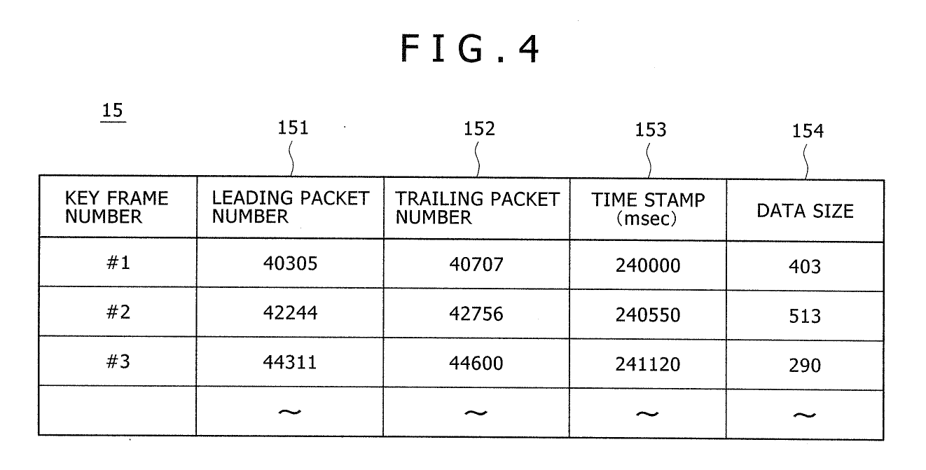

FIG. 4 shows an example of the structure of the key frame management table 15 which the video distribution apparatus 1 holds in the database 14.

The key frame management table 15 describes pieces of positional information on key frames included in each of the contents 13 held in the media accumulation unit 12. As for the contents of the description, an item 151 indicates a key frame leading packet number, an item 152 indicates a key frame trailing packet number, and an item 153 indicates a time stamp. An item 154 is included for an explanatory purpose and indicates the data size of each key frame in the unit of the number of packets. Data of each frame is structured as a string of packets each of predetermined bytes long. The key frame leading packet number 151 is a number assigned to a leading packet of a key frame and expressed with a count value obtained by counting up packets, which constitute a content, from the leading packet of the content. The key frame trailing packet number 152 is a number assigned to a trailing packet of a key frame. By managing the leading packet number 151 and trailing packet number 152, the position of a key frame in a packet string can be identified and searched. The time stamp 153 expresses a time instant at which a key frame should be played in normal play mode, and is used to search a key frame on the basis of a time instant. Herein, the time stamp 153 is expressed in the unit of milliseconds. However, the unit may be changed to another according to the operational specifications for the video distribution apparatus 1. The data size 154 of each key frame is expressed with the number of packets starting with the leading packet number 151 and ending with the trailing packet number 152. Similarly to this example, the interval between adjoining key frames employed in the present embodiment shall be unequal, and the data size of each key frame shall not be uniform.

The data size of one packet varies depending on a multiplexing format adapted to a content. In the case of a transport stream (TS) format to be employed by a MPEG2 system, the unit of a TS packet is 188 bytes. In the case of a time stamp transport stream (TTS) format to be employed by the MPEG2 system, the unit of a TTS packet is 192 bytes.

In the TS format, the time stamp includes a program clock reference (PCR), a presentation time stamp (PTS), and a decoding time stamp (DTS).

The trick play control unit 16 included in the video distribution apparatus 1 references the key frame management table 15 shown in FIG. 4, and designates the positional information of a key frame that should be transmitted (leading packet number 151 and trailing packet number 152) and a transmission start time instant for the stream transmission unit 17. The stream transmission unit 17 reads packets, which coincide with a range indicated with the designated positional information (from the leading packet number to the trailing packet number), from the media accumulation unit 12, and transmits the packets at the designated transmission start time instant. Incidentally, the bit rate at which a stream is transmitted shall remain unchanged for each content. Consequently, whether a certain content is transmitted in trick play mode such as fast-forward mode or in normal play mode, the content is transmitted at the same bit rate.

Since an accumulated content is multiplexed, a packet string to be transmitted may contain not only data of key frames but also audio data and data of caption. For decoding in trick play, the decoding unit 23 included in the video receiver 2 discards data other than data of key frames. Therefore, even when data other than data of key frames is contained in a transmitted stream, reproduction will not be hindered. Consequently, a description will proceed on the assumption that packets falling within a range from the key frame leading packet number 151 to the key frame tailing packet number 152 are regarded and treated as packets constituting a key frame.

For trick play, each key frame is transmitted at a designated transmission time instant. However, when the transmission interval between frames is long, the time during which data transmission is discontinued takes place. In this case, occurrence of an error in video delivery may be recognized depending on the specifications for the video receiver 2, and reception and reproduction may be suspended. As a countermeasure, null packets are transmitted between key frame transmissions. Consequently, reception and reproduction can be performed stably irrespective of the specifications for the video receiver 2.

The trick play control unit 16 included in the present embodiment decides whether each of key frames constituting a designated content and being subjected to trick play can be transmitted in order of being played. A criterion is that a predetermined transmission bit rate determined for each content should not be exceeded. Specifically, a decision is made on whether the transmission completion time instant of a preceding key frame and the transmission start time instant of a succeeding key frame are incompatible with each other. The scheduled transmission start time instant and transmission completion time instant of each key frame are calculated as described later.

When the transmission start time instant of a succeeding key frame comes later than the transmission completion time instant of a preceding key frame (namely, the transmission start time instant and transmission completion time instant are compatible with each other), the succeeding key frame is transmitted at the calculated time instant. If the transmission start time instant of the succeeding key frame comes earlier than the transmission completion time instant of the preceding key frame (namely, the transmission start time instant and transmission completion time instant are incompatible with each other), the succeeding key frame is not transmitted but a decision is made on whether the next key frame can be transmitted.

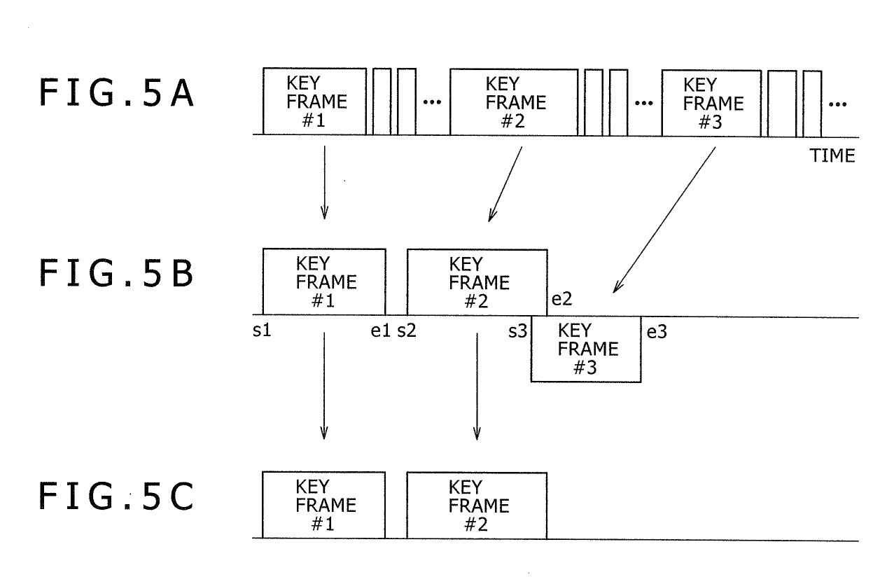

FIG. 5A to FIG. 5C are explanatory diagrams concerning a decision to be made on whether a key frame can be transmitted. FIG. 5A shows the structure of a stream to be normally played. A stream to be transmitted is formed with a sequence of key frames (1, 2, and 3) and other frames (coded in inter-frame coding) interposed among the key frames. An axis of abscissas serves as a time base. The key frames 1, 2, and 3 are played in that order. FIG. 5B shows the positions of key frames to be transmitted during fast-forward trick play. In this example, the key frames 1, 2, and 3 shall be transmitted in that order. The time instants at which the respective key frames should be transmitted are calculated. The transmission start time instant of the key frame 1 shall be a time instant s1 and the transmission completion time instant thereof shall be a time instant e1. Likewise, the transmission start time instants of the key frames 2 and 3 shall be time instants s2 and s3 respectively, and the transmission completion time instants thereof shall be time instants e2 and e3 respectively. In this example, the transmission times of the key frames 2 and 3 overlap. Namely, the transmission start time instant s3 of the succeeding key frame 3 comes earlier than the transmission completion time instant e2 of the preceding key frame 2. In other words, the leading data of the key frame 3 and the trailing data of the key frame 2 are temporally superposed on each other. The succeeding key frame cannot be transmitted at a predetermined transmission bit rate. In this case, as shown in FIG. 5C, the transmission of the succeeding key frame 3 is canceled. Namely, the key frame 3 is thinned out.

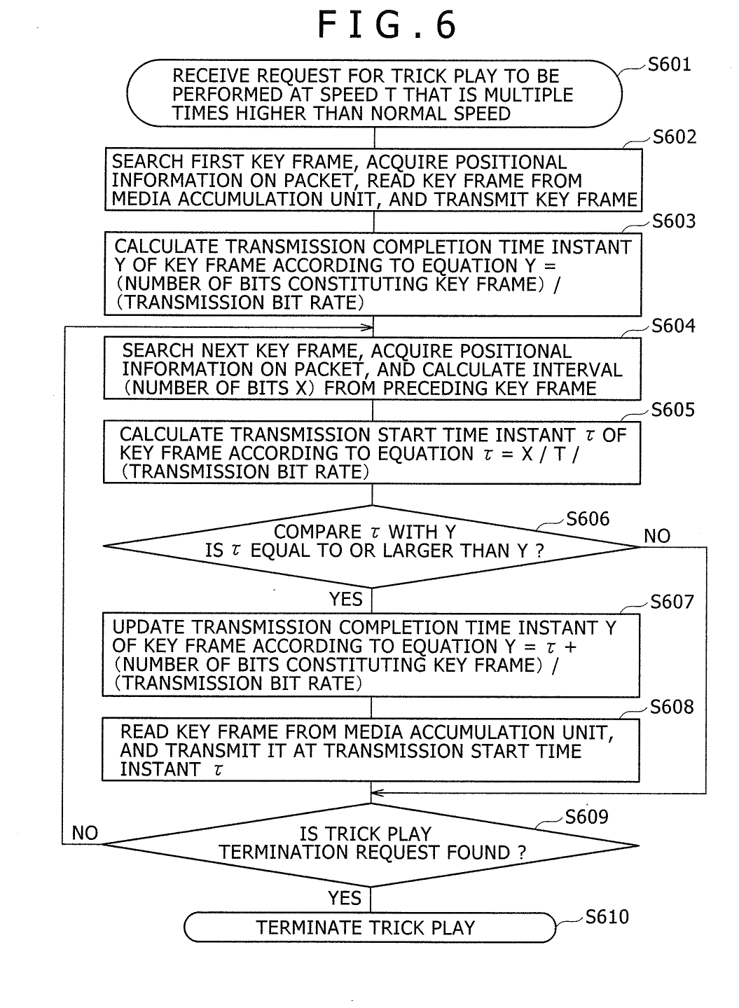

FIG. 6 is a flowchart describing a flow of distribution to be performed by the video distribution apparatus 1 in accordance with the present embodiment, wherein the flow of distribution includes calculating transmission time instants of key frames and deciding whether each key frame can be transmitted.

At step S601, the play control command reception unit 11 included in the video distribution apparatus 1 shall receive a request for fast-forward trick play of a content 13, which is performed at a speed T that is multiple times higher than a normal speed, from the play control command transmission unit 21 included in the video receiver 2. When a play control command is a request for fast-forward trick play, the play control command reception unit 11 transfers the received play control command to the trick play control unit 16.

At step S602, the trick play control unit 16 receives the play control command (request for fast-forward trick play to be performed at a speed T that is multiple times higher than a normal speed). The trick play control unit 16 then references the key frame management table 15 shown in FIG. 4 so as to search the first key frame (key frame 1) to be transmitted. Moreover, the trick play control unit 16 acquires as the positional information on the key frame 1 the leading packet number 151 and trailing packet number 152. Herein, the leading packet number shall be A. The acquired positional information and a transmission start time instant are transferred to the stream transmission unit 17. The transmission start time instant is the transmission start time instant of a requested content.

For convenience' sake, the transmission of the content shall begin at a time instant 0. The stream transmission unit 17 reads data of the key frame 1 relevant to the positional information read from the media accumulation unit 12, and transmits the key frame data as a stream.

In the video receiver 2, the stream reception unit 24 receives the key frame 1, and the decoding unit 23 and play unit 25 plays a picture. At this time, the decoding unit 23 receives control data, which signifies that fast-forward play is executed, from the play control command transmission unit 21. In the subsequent processing, a time stamp is ignored and key frames alone are decoded so that a picture can be played in fast-forward mode.

At step S603, the transmission completion time instant Y of the key frame 1 is calculated. For calculation of the data size of a key frame, the number of packets constituting the key frame is obtained by calculating a difference between a leading packet number and a trailing packet number. Moreover, the capacity (packet size) of one packet is set to a fixed value (the packet size of a TS packet is 188 bytes, while the packet size of a TTS packet is 192 bytes). The number of packets is multiplied by the fixed packet size in order to obtain the data size of the key frame (number of bits). Assuming that the transmission start time instant is 0 and the key frame 1 is transmitted at a certain bit rate, the transmission completion time instant Y is calculated according to an equation (1).
Y=(number of bits constituting a key frame)/(transmission bit rate) (1)
Herein, the transmission bit rate shall be held constant for each content 13.

At step S604, the key frame management table 15 is referenced in order to search a key frame to be transmitted next (key frame 2). Moreover, the leading packet number of the next key frame 2 is checked, and an interval from the leading packet number A of the previously transmitted key frame 1 is obtained in the unit of the number of packets. The interval is multiplied by the packet size, whereby the interval from the packet number A can be calculated in the unit of the number of bits X.

At step S605, the transmission start time instant τ of the key frame 2 is calculated. The transmission start time instant τ lags behind the transmission start time instant (herein, the time instant equals 0) of the previously transmitted key frame 1 by the interval to the key frame 2 (that is, the time required for transmission of bits X).

However, the interval is extended or shortened according to a condition for trick play. In order to achieve fast-forward trick play at a speed T that is multiple times higher than a normal speed, the transmission interval is shortened to be a 1/T of that for normal play. Herein, the transmission start time instant τ is calculated according to an equation (2).
τ=X/T/(transmission bit rate) (2)

At step S606, the value Y provided by the equation (1) is compared with the value τ provided by the equation (2). If the result of the comparison demonstrates that τ≧Y is established, the transmission start time instant τ of the key frame 2 comes later than the transmission completion time instant Y of the key frame 1 (that is, the transmission start time instant and transmission completion time instant are compatible with each other). In this case, control is passed to step S607, and the key frame 2 is transmitted.

At step S607, the transmission completion time instant of the key frame 2 is calculated in order to update the transmission completion time instant Y. The transmission completion time instant Y is calculated by adding the value (transmission time), which is calculated relative to the key frame 2 using the equation (1), to the transmission start time instant τ obtained using the equation (2), that is, calculated according to an equation (3).
Y=τ+(number of bits constituting a key frame)/(transmission bit rate) (3)

At step S608, the leading packet number, trailing packet number, and transmission start time instant τ of the key frame 2 are transferred to the stream transmission unit 17. The stream transmission unit 17 reads data of the key frame 2 from the media accumulation unit 12 on the basis of designated positional information, and transmits the key frame data as a stream at the designated transmission start time instant τ. Thereafter, control is passed to step S609.

If the result of the comparison performed at step S606 demonstrates that τ<Y is established, the transmission start time instant τ of the key frame 2 comes earlier than the transmission completion time instant Y of the key frame 1 (that is, the transmission start time instant and transmission completion time instant are incompatible with each other). In this case, the key frame 2 is not transmitted, but control is passed to step S609.

At step S609, whether a trick play termination request is found is decided. The play control command reception unit 11 receives the trick play termination request from the video receiver 2. The trick play termination request is a command for terminating trick play of a content being transmitted. If the termination request is unfound, control is returned to the processing of step S604. Whether the next key frame (key frame 3) can be transmitted is decided. If the next key frame 3 can be transmitted, the key frame 3 is transmitted. Thereafter, the foregoing procedure is repeatedly executed until the trick play termination request is received.

If the trick play termination request is received at step S609, processing relevant to trick play is terminated at step S610. The play control command reception unit 11 instructs the trick play control unit 16 to terminate the processing. The trick play control unit 16 terminates ongoing trick play. The play control command reception unit 11 transmits control data, which signifies that the trick play is terminated normally, to the play control command transmission unit 21 included in the video receiver 2. In response to the control data, the play control command transmission unit 21 instructs the decoding unit 23 to terminate decoding relevant to trick play and to switch the decoding into decoding relevant to normal play.

Processing to be performed for fast-forward trick play that is trick play has been described so far. Even for rewind trick play, the same procedure as the foregoing one can be adopted. For rewind play, search of key frames to be performed at step S602 and step S604 is carried out in an opposite direction on the time base (for example, in the order of key frames 3, 2, and 1). A leading packet number and a trailing packet number included in the positional information of each key frame are switched and designated in a direction opposite to a direction in which they are designated for fast-forward trick play. Owing to this change, rewind trick play can be achieved as described in the foregoing flowchart.

As mentioned above, according to the present embodiment, the start time instant and completion time instant of each of key frames to be used for trick play are calculated. A decision is made on whether even when successive key frames are transmitted, frames do not temporally overlap. If frames overlap, the transmission of the succeeding one of the frames is canceled. Consequently, even when the transmission interval between adjoining key frames is unequal, key frames can be transmitted at correct transmission time instants. Moreover, trick play to be performed at an arbitrary speed that is multiple times higher than a normal speed can be readily achieved. Moreover, even when the data size of a key frame is not uniform, transmission can be achieved with a predetermined bit rate not exceeded. Further, since a decision is made on whether each of key frames to be transmitted can be transmitted, key frames constituting a content can be made the most of and transmitted. Transmittable frames will never be thinned out. Eventually, a high-frame rate and high-quality picture can be reproduced.

### Second Embodiment

In the first embodiment, the transmission start time instant and transmission completion time instant of each key frame are calculated on the assumption that the stream reception unit 24 included in the video receiver 2 receives a leading packet of each key frame and the decoding unit 23 immediately decodes a stream of received key frames. In this case, since the timing of decoding each frame squares with the timing of transmitting it, no problem occurs. Even when decoding is begun in a certain time after reception, the processing time instants of respective frames are uniformly shifted. Consequently, the timings of decoding respective frames will not become inconsistent.

In the second embodiment, data received by the video receiver 2 shall be temporarily stored in a buffer memory. When data of one key frame has been stored, decoding shall be begun. In this case, the decoding timing does not always square with the transmission timing. In order to perform decoding at correct timing, a transmission start time instant has to be adjusted according to the data size of a key frame.

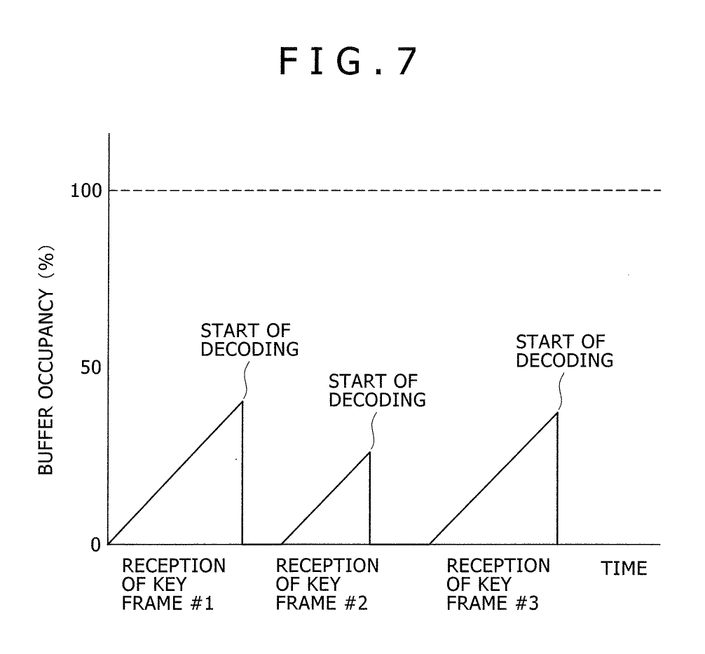

FIG. 7 shows a temporal change in the occupancy of a buffer included in the stream reception unit 24 incorporated in the video receiver 2. In FIG. 7, data items constituting a stream to be transmitted at a predetermined bit rate are sequentially stored in the buffer. When data of one key frame has been stored (namely, when a trailing packet has been received), the decoding unit 23 fetches the data from the buffer and begins decoding the data. Successively, the play unit 25 executes visualization. In the processing method, when the data size of each key frame is not uniform, the accumulation time thereof is not uniform. Consequently, the timing of beginning decoding (visualizing) each key frame becomes inconsistent. In the second embodiment, the inconsistency in the decoding timing is resolved.

In the first embodiment, the leading packet of a key frame is regarded as a reference for determining a transmission time instant. In the second embodiment, the trailing packet of a key frame is regarded as the reference for determining a transmission time instant. Specifically, the transmission time instant of the leading packet of a key frame is shifted so that the transmission time instant of the trailing packet thereof will be correct. A degree of shift shall be equivalent to a difference between the transmission time of a preceding key frame and the transmission time of a succeeding key frame. Consequently, even when the accumulation time of each key frame varies, the key frame can be decoded (visualized) at correct timing. The same applies to a case where the trailing packet of a key frame is received, delayed for a certain time, and then decoded. Moreover, the second embodiment can be applied to a configuration in which: the decoding unit 23 sequentially fetches image data items from the stream reception unit 24, and then decodes them; and when decoding of one key frame is completed, the play unit 25 is instructed to perform visualization.

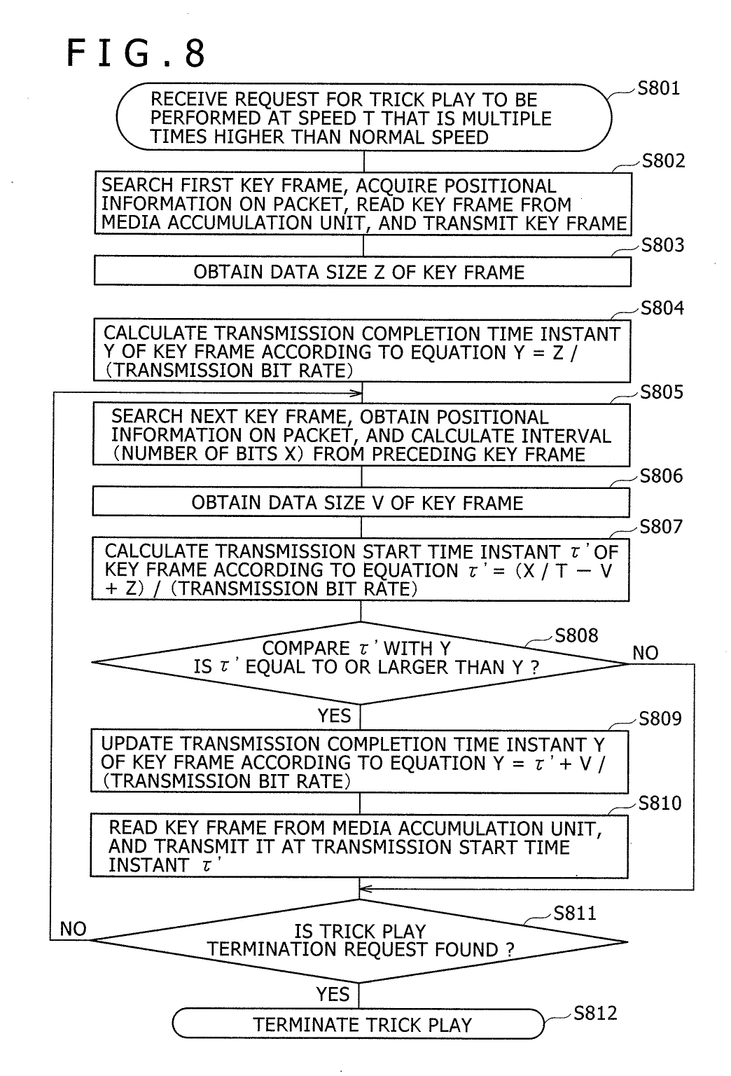

FIG. 8 is a flowchart describing a flow of distribution performed in the present embodiment, wherein the flow includes calculating the transmission time instant of each key frame and deciding whether each key frame can be transmitted.

At step S801, the play control command reception unit 11 included in the video distribution apparatus 1 shall receive a request for fast-forward trick play, which is performed at a speed T that is multiple times higher than a normal speed, of a content 13 from the video receiver 2.

At step S802, the trick play control unit 16 receives the play request, and references the key frame management table 15 shown in FIG. 4 so as to search the first key frame (key frame 1) to be transmitted. Moreover, the trick play control unit 16 acquires the leading packet number 151 and trailing packet number 152 as the positional information on the key frame 1. Herein, the leading packet number shall be A. The acquired positional information and a transmission start time instant are transferred to the stream transmission unit 17. The transmission start time instant shall begin with a time instant 0. The stream transmission unit 17 reads data of the key frame 1 relevant to the positional information read from the media accumulation unit 12, and transmits the data as a stream.

At step S803, the data size z (number of bits) of the first key frame 1 to be transmitted is calculated. The value is calculated using the number of packets starting with the leading packet number 151 and trailing packet number 152, and the capacity (packet size) of one packet.

At step S804, the transmission completion time instant Y of the key frame 1 is calculated. Herein, since the transmission start time instant is set to 0, the value of the transmission completion time instant Y is calculated according to an equation (4).
Y=(number of bits Z constituting a key frame)/(transmission bit rate) (4)
Even in this case, the transmission bit rate remains unchanged.

At step S805, the key frame management table 15 is referenced in order to search a key frame (key frame 2) to be transmitted next. Moreover, the leading packet number of the next key frame 2 is obtained, and the interval from the leading packet number A of the previously transmitted key frame 1 is obtained in the unit of the number of packets. Further, the interval is multiplied by the packet size, whereby the interval from the packet number A is calculated in the unit of the number of bits X.

At step S806, the data size V (number of bits) of the key frame 2 is obtained.

At step S807, the transmission start time instant τ′ of the key frame 2 is obtained. Herein, the transmission start time instant is adjusted so that the trailing packet will be transmitted at correct timing. The transmission start time instant τ′ is calculated according to an equation (5).
τ′=(X/T−V+Z)/(transmission bit rate) (5)
The equation (5) is identical to the equation (2), which provides the transmission start time instant τ in the first embodiment, except that (V−Z) is subtracted from the number of bits to be transmitted. Namely, the number of bits is changed from the value Z to the value V between the key frames 1 and 2. Consequently, the transmission time instant of a trailing packet is deviated by an equivalent of (V−Z) from an original time instant. Therefore, the transmission start time instant of the leading packet is adjusted by the difference. In other words, the transmission start time instant of the key frame 2 is adjusted to become earlier by the increase in the transmission time of the key frame 2 relative to the transmission time of the preceding key frame 1.

At step S808, the value Y provided by the equation (4) and the value τ′ provided by the equation (5) are compared with each other. If the result of the comparison demonstrates that τ′≧Y is established, the transmission start time instant τ′ of the key frame 2 comes later than the transmission completion time instant Y of the key frame 1 (that is, the transmission start time instant and transmission completion time instant are compatible with each other). In this case, control is passed to step S809, and the key frame 2 is transmitted.

At step S809, the transmission completion time instant of the key frame 2 is calculated and the transmission completion time instant Y is updated. The transmission completion time instant Y is obtained by adding the transmission start time instant τ′ provided by the equation (5) to the value (transmission time) calculated relative to the key frame 2 using the equation (4), that is, obtained according to an equation (6).
Y=T′+V/(transmission bit rate) (6)

At step S810, the leading packet number, trailing packet number, and transmission start time instant τ′ of the key frame 2 are transferred to the stream transmission unit 17. The stream transmission unit 17 reads data of the key frame 2 relevant to the positional information from the media accumulation unit 12, and transmits the data as a stream at the designated transmission start time instant τ′. After the completion of the transmission, control is passed to step S811.

If the result of the completion performed at step S808 demonstrates that τ′<Y is established, the transmission start time instant τ′ of the key frame 2 comes earlier than the transmission completion time instant Y of the key frame 1 (that is, the transmission start time instant and transmission completion time instant are incompatible with each other). In this case, the key frame 2 is not transmitted, but control is passed to step S811.

At step S811, whether a trick play termination request is found is decided. If the termination request is unfound, control is returned to the processing of step S805. A decision is then made on whether the next key frame (key frame 3) can be transmitted. If the key frame 3 can be transmitted, the key frame 3 is transmitted. Thereafter, the above procedure is repeated until the trick play termination request is received. If the trick play termination request is received at step S811, processing relevant to trick play is terminated at step S812.

Processing to be performed in a case where fast-forward trick play is designated as trick play has been described so far. Even in the case of rewind trick play, the same procedure as the aforesaid one can be adopted. For rewind trick play, key frames are searched in an opposite direction on the time base, and a leading packet number and a trailing packet number included in the positional information on each key frame are switched and designated in a direction opposite to the direction in which the leading packet number and trailing packet number are designated for fast-forward trick play. Owing to the change, rewind trick play can be achieved as described in the aforesaid flowchart.

In the second embodiment, data received by the video receiver 2 is temporarily stored in the buffer. When data of one key frame has been stored, decoding is begun. In this case, a key frame is transmitted with the transmission time instant thereof adjusted so that decoding can be performed at original timing. Decoding will not be hindered at all.

Similarly to the first embodiment, a decision is made on whether key frames to be transmitted temporally overlap. If key frames to be transmitted temporally overlap, the transmission of the succeeding one of the key frames is canceled. Consequently, data can be transmitted with a predetermined transmission bit rate not exceeded by the data size thereof. Moreover, since key frames constituting a content are made the most of and transmitted, a high-frame rate and high-quality picture can be played.

In relation to the aforesaid first and second embodiments, a video distribution system that is a video-on-demand (VOD) system has been described. The present invention is not limited to the system. Needless to say, the present invention can be applied to a video transferring system that includes a home server installed at home.

What is claimed is:

1. A video transferring apparatus that transfers an accumulated video content in response to a request sent from a video receiver, comprising:
a play control command reception unit that receives a request for trick play of a video content from the video receiver;
a recording unit in which the video contents are recorded;
a key frame management unit in which pieces of information on key frames that are used for trick play and included in a video content to be recorded in the recording unit are stored;
a stream transmission unit that reads a video content from the recording unit and transmits the video content to the video receiver; and
a trick play control unit that references the key frame management unit so as to sequentially select key frames, which should be transmitted, in response to the trick play request received by the play control command reception unit, and instructs the stream transmission unit to read and transmit the selected key frames.

2. The video transferring apparatus according to claim 1,
wherein: the trick play control unit calculates the transmission start time instant and transmission completion time instant of each of the key frames that should be transmitted, and decides whether the transmission completion time instant of a preceding key frame and the transmission start time instant of a succeeding key frame are incompatible with each other;
if the transmission completion time instant and transmission start time instant are incompatible with each other, the trick play control unit cancels the transmission of the succeeding key frame; and
if the transmission completion time instant and transmission start time instant are compatible with each other, the trick play control unit extends control so that the succeeding key frame will be transmitted at the transmission start time instant.

3. The video transferring apparatus according to claim
wherein: the key frame management unit holds the leading packet number, trailing packet number, and time stamp of each key frame;
the trick play control unit checks the leading packet number of each key frame for the transmission start time instant of each key frame, and designates the transmission start time instant by extending or shortening the interval between adjoining transmission start time instants according to a requested speed of trick play; and
the trick play control unit checks the leading packet number and trailing packet number of each key frame for the transmission completion time instant of each key frame, and designates the transmission completion time instant by adding the time, which is required for transmission of each key frame at a predetermined bit rate, to the transmission start time instant.

4. The video transferring apparatus according to claim 3,
wherein the trick play control unit makes the transmission start time instant of each key frame earlier by an increase in the transmission time of the key frame relative to the transmission time of a previously transmitted key frame.

5. A video transferring method for transferring a recorded video content in response to a user's request, comprising the steps of:
in response to a request for trick play of a video content received from a user, sequentially searching key frames, which are used for trick play, from an accumulated video content;
calculating the transmission start time instant and transmission completion time instant of each key frame according to a condition for requested trick play;
deciding whether the transmission completion time instant of a preceding key frame and the transmission start time instant of a succeeding key frame are incompatible with each other;
if the transmission completion time instant and transmission start time instant are incompatible with each other, canceling the transmission of the succeeding key frame; and
if the transmission completion time instant and transmission start time instant are compatible with each other, transmitting the succeeding key frame at the transmission start time instant.

6. The video transferring method according to claim 5,
wherein: the transmission start time instant of each key frame is designated by extending or shortening the interval between adjoining transmission start time instants according to a requested speed of trick play; and
the transmission completion time instant of each key frame is designated by adding the time, which is required for transmission of the key frame at a predetermined bit rate, to the transmission start time instant.

7. The video transferring method according to claim 6,
wherein the transmission start time instant of each key frame is made earlier by an increase in the transmission time of the key frame relative to the transmission time of a previously transmitted key frame.

8. A video transferring method for, in response to a request for trick play of a video content received from a user, sequentially selecting key frames, which are used for requested trick play, from a recorded video content, and transmitting the key frames, the method comprising the steps of:
canceling the transmission of the selected key frame, when the transmission time of a selected key frame overlaps the transmission time of a preceding key frame; and
transmitting each key frame with a predetermined bit rate not exceeded.
